(19) United States
(12) Patent Application Publication
(10) Pub. No.: US 2025/0157244 A1
(43) Pub. Date: May 15, 2025

(54) METHODS AND SYSTEMS FOR PROCESSING DIGITAL DOCUMENTS

(71) Applicant: Express Scripts Strategic Development, Inc., St. Louis, MO (US)

(72) Inventors: Sridhar Talluri, Ellington, CT (US); David Bradshaw, Charleston, SC (US); Sridhar Srinivasan, Burlington, CT (US); Taylor VanCoevering, Broussard, LA (US); Chandrasekaran Murali, South Windsor, CT (US)

(21) Appl. No.: 18/509,491

(22) Filed: Nov. 15, 2023

(51) Int. Cl. G06V 30/416; G06F 16/93; G06F 40/186; G06V 30/14; G06V 30/146; G06V 30/19; G06V 30/22; G06V 30/30; G06V 30/42

(52) U.S. Cl. CPC G06V 30/416; G06F 16/93; G06F 40/186; G06V 30/1448; G06V 30/1468; G06V 30/19013; G06V 30/19147; G06V 30/22; G06V 30/30; G06V 30/42

(57) ABSTRACT

Methods and systems for processing digital files are described. In one embodiment, a digital document processing subsystem monitoring a database location for a file to process, after identifying a file to process, identifying a location of one or more multiple-choice selection areas within the file, and determining whether each of the one or more multiple choice selection areas were marked by hand and storing results of the determination in a database.

### FIELD

The present disclosure relates generally to the technical field of data processing. In a specific example, the present disclosure may relate to receiving digital documents and processing the digital documents with handwritten aspects contained therein.

### BACKGROUND

Many forms are still filled out by hand. For example, when a patient enters a doctor's office, the patient is provided with a clipboard, pen, and a paper form to fill out. These paper forms can include both handwritten answers, check boxes, circled answers, or multiple-choice selections. Alternatively, during health emergencies, companies may request their employees to fill out paper forms as part of a contact tracing audit to prevent the further spread of a dangerous disease. These handwritten or hand-filled forms can be scanned into a computer to capture an image of the filled-out form, but commonly, a human must still enter the answers into a computer manually. For example, an assistant at the doctor's office may read the handwritten form and manually type in the answers through common data entry methods. Manual data entry is time-consuming and onerous.

### BRIEF DESCRIPTION OF THE DRAWINGS

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4 is a block diagram of an example benefit manager device that may be deployed within the system of FIG. 1, according to an example embodiment;

FIG. 5 is a block diagram of a flowchart illustrating methods for processing handwritten forms, according to an example embodiment;

FIGS. 6A and 6B are exemplary hand-filled forms, according to an exemplary embodiment.

FIG. 7 is a block diagram of a flowchart illustrating methods for processing handwritten forms, according to an example embodiment;

FIG. 8 is an exemplary user interface showing a result of processed forms, according to an exemplary embodiment; and

FIG. 9 is a block diagram of a flowchart illustrating methods for processing documents, according to an example embodiment.

### DETAILED DESCRIPTION

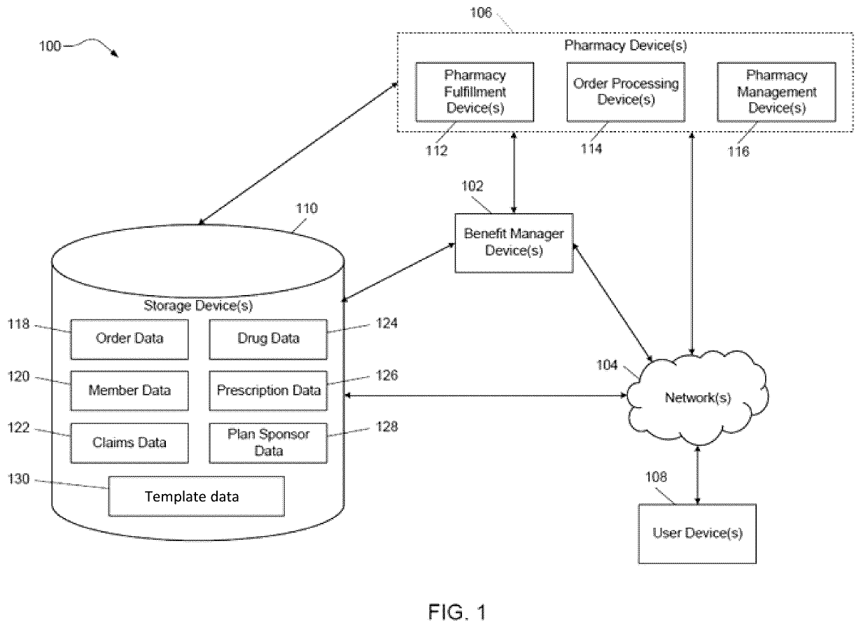

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104. The system 100 may also include a storage device 110.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription from a physician, and the member may seek to receive a prescription drug from a pharmacy. The prescription drug may require prior authorization from a health plan provider prior to dispensing the drug, and the PBM may request prior authorization. Upon receiving authorization approval, the member may obtain the prescription drug. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device 108, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in the storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member, receiving authorization approval, and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. The PBM may also perform automatic prior authorization with the claim submission, which may include determining whether to cover some or all of the costs related to dispensing the prescription drug, determining whether any cheaper alternative drugs may substitute for the prescription drug, determining whether the member can afford the costs to receive the prescription drug, and negotiating a lower price for the prescription drug on behalf of the member when the member cannot afford the full-price of the prescription drug. Further, the PBM may provide a response to the pharmacy (for example, the pharmacy system 100) following performance of at least some of the aforementioned operations, which many include approval or denial of the claim as a result of performing prior authorization.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfilment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, plan sponsor data 128, and/or form template data 130. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, address, telephone number, e-mail address, prescription drug history, etc. The member data 120 may include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the use of the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member).

The drug data 124 may include drug name (e.g., technical name and/or common name), other names by which the drug is known, active ingredients, an image of the drug (such as in pill form), etc. The drug data 124 may include information associated with a single medication or multiple medications. The drug data 124 may further include an indicator specifying whether prior authorization is required before dispensing each drug.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

Furthermore, form template data 130 can include data regarding recognized form formats, including a form name, locations of checkboxes within a page of a form, locations for blanks where handwritten answers may appear, or any other features of a form. The form template data 130 may be prestored or generated in response to recognizing a new form not previously processed by the benefit manager device 102. The form template data may further include a number of pages in each form, a number of pixels in each form, and digital data representing whether each pixel in the form represents whitespace or a printed area (e.g. using a 0 for whitespace and a 1 for black, printed area). The form template data can further include coordinate data indicating locations of checkboxes or other anchor marks, such as the location of blanks where handwriting may appear.

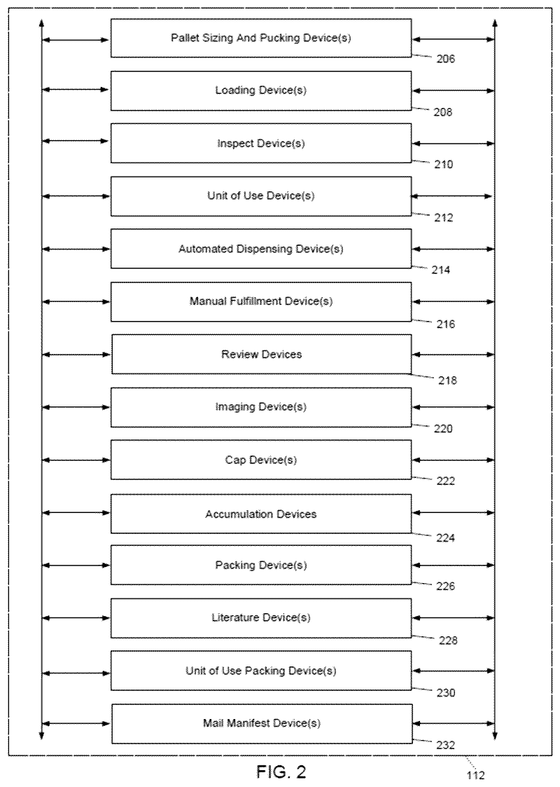

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

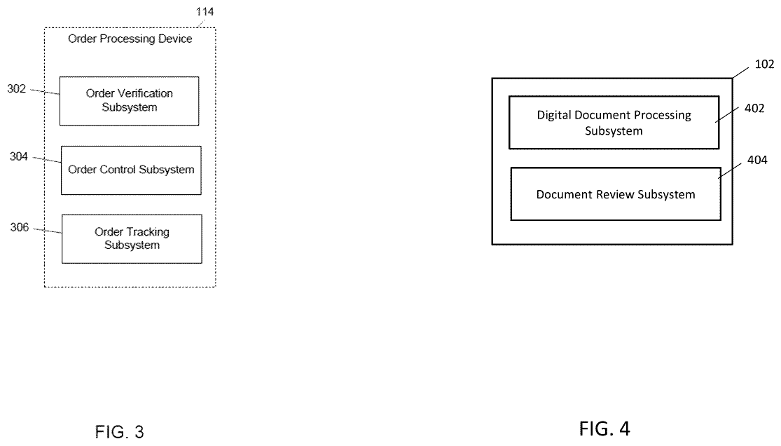

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may include order related components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

FIG. 4 illustrates the benefit manager device 102, according to an example embodiment. The benefit manager device 102 may be deployed in the system 100, or may otherwise be used. The benefit manager device 102 may include a digital document processing subsystem 402 and a document review subsystem 404.

According to an exemplary embodiment, the digital document processing subsystem 402 can scan a database location (e.g., folder or set of folders) for files that have not been processed and process any new files found within the database location. In some embodiments, processing the files within the database location can include processing scanned forms or other documents to convert the information written on the form or document into a computer-readable format, which can be searchable or used for other data analysis purposes. For example, a new file stored in the database location can be a scanned form filled out by hand by a human, and the digital document processing subsystem 402 can process the scanned form to interpret any handwritten words and interpret any hand drawn markings within any checkboxes, hand drawn circles around any multiple choice options, or any other form indicator. The scanned form may be in the form of a PDF document, a digital image file (e.g., JPEG, PNG, TIFF etc.), a Word document or any other digital file.

The digital document processing subsystem 402 may also scan a document to determine whether the digital document processing subsystem 402 recognizes the form's format. The digital document processing subsystem 402 can process the pixels of the scanned form to determine the language used on the form, determine the locations of any checkboxes or form boxes by identifying rectangles or other shapes in the form, and any other method for determining the form's format. The digital document processing subsystem 402 can do this process on a page-by-page basis or on a document-by-document format. If the form's format or pattern is recognized, the digital document processing subsystem 402 can use the recognized format as a template for determining which form entries include handwriting answers, which checkboxes include hand-drawn markings, or which selectable choices include handwritten selection indicators. If the digital document processing subsystem 402 does not recognize the form's format, the digital document processing subsystem 402 can create a new form template by removing any handwriting and hand drawn markings and learning the locations of any checkboxes, blanks for handwriting, multiple choice answer locations, etc. The digital document processing subsystem 402 can find corners of boxes or coordinates of lines within boxes to create bases of coordinates. In some embodiments, the digital document processing subsystem 402 can determine the location of all straight lights in the form representing selection boxes or blanks where handwritten answers are expected.

After processing a scanned file, the digital document processing subsystem 402 can store determined answers based on processing any handwritten entries or hand-drawn markings into a database in a computer-readable format. For example, a form can include a section for a person to write his or her name, his or her date of birth, and three Yes or No checkboxes asking 1) whether the person has been in contact with anyone who tested positive for COVID-19, 2) whether the person is feeling any symptoms of COVID-19, and 3) whether the person has travelled outside the country in the last 14 days. The digital document processing subsystem 402 can process a scanned form having this format, recognize the format as a known COVID-19 contact tracing form, reference a template of the COVID-19 contact tracing form, find the location of the handwriting answers for the name and birthdate, find the location of the three Yes or No checkboxes, use handwriting OCR technology to determine the name and birthdate written by hand, and determine whether each the yes or no checkbox was marked by hand. Upon determining the answers to these five form entries, the digital document processing subsystem 402 can store the answers in a database. For example, the digital document processing subsystem 402 may determine that “John Smith” filled out the form, having a birthday of Jan. 1, 1990, and John Smith answered “No” to each of the three contact tracking questions.

The document review subsystem 404 can review s location or locations in a database to find digital documents stored in the database. In some embodiments, the digital documents can be signed and executed contracts binding a company, such as the PBM. A large company may be subject to thousands of contracts with vendors, customers, and other third-parties, and digital versions of these contract may exist in numerous stored locations (cloud, shared drives, share point, databases, etc.). The document review subsystem 404 may be configured to gather and process the digital documents stored across various locations, perform optical character recognition (OCR) where necessary, make the document searchable, and use machine learning or other artificial intelligence to identify keywords within each digital document. The document review subsystem 404 can analyze the digital documents to generate visualization of the keywords and provide insights for each digital document. For example, the document review subsystem 404 can understand contractual obligations with third parties by analyzing and deciphering contracts. For example, the document review subsystem 404 might process a digital document and determine that the digital document is a non-disclosure agreement with a former employee. The document review subsystem 404 can identify keywords like the former employee's name, the term “non-disclosure agreement” or NDA, and any other relevant keywords. The document review subsystem 404 can further determine the term of the NDA, the scope of the NDA, and the subject matter disclosed or known to the former employee. These insights can be saved as metadata associated with the digital document for quick reference later by a human or other data analysis programs.

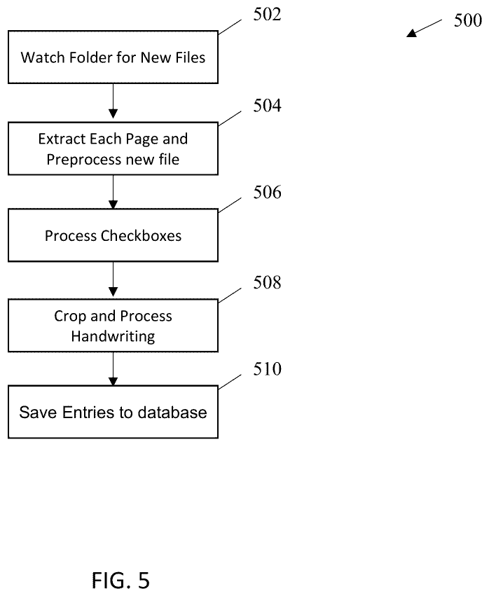

FIG. 5 illustrates a method 500 for processing handwritten forms according to an example embodiment. The method 500 may be performed by the benefit manager device 102, partially by the benefit manager device 102 and partially by another device, or may be otherwise performed. For the sake of simplicity, the digital document processing subsystem 402 will be described as performing the steps of the method 500, but the embodiments described herein are not so limited.

According to an exemplary embodiment, the digital document processing subsystem 402 can watch a database location, such as a folder that receives scanned versions of hand-filled forms, to find new files added to the database location in step 502. In some embodiments, the new files can be scanned PDFs (or other filetype), which were scanned after a human filled out a form. The digital document processing subsystem 402 can watch the database by, for example, running a “cron” job that repeats according to a predetermined schedule, such as repeating every minute. In some embodiments, the digital document processing subsystem 402 can rename processed files (e.g., “FILENAME.DON.PDF”) after processing the file. Thus, the digital document processing subsystem 402 can determine that a new file has been added to the database location upon determining that the new file lacks the renaming convention (e.g., file name lacks the string “.DONE.”). Upon finding a new file to process, the digital document processing subsystem 402 can extract each page of the new file into separate pages, in step 504, so that each page can be processed individually. In some embodiments, the digital document processing subsystem 402 can filter out any unnecessary data from the new file, such as a cover page or QR codes included within a page of the new file.

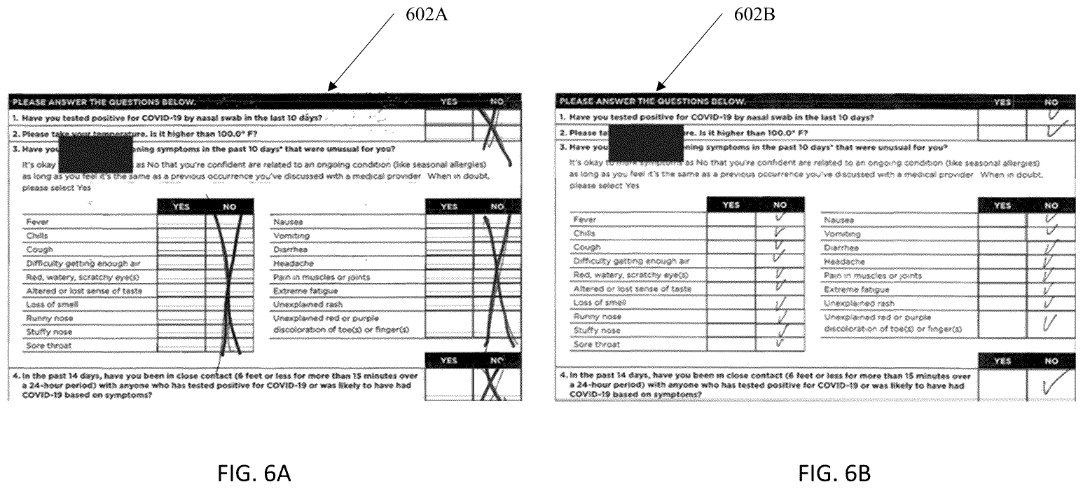

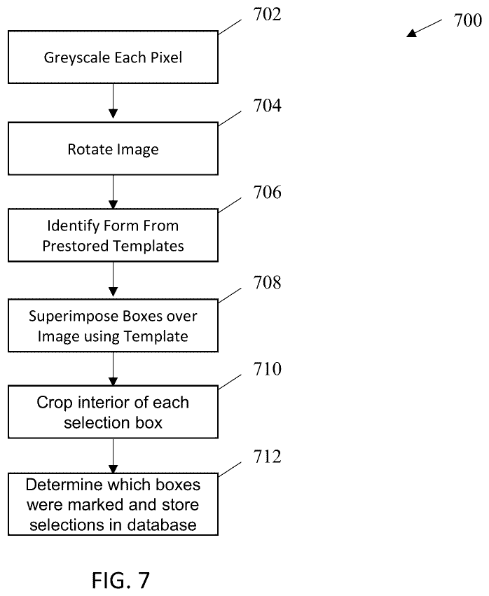

Subsequently, for each page, the digital document processing subsystem 402 can determine the location of checkboxes or other places in the form where a selection from multiple options can occur and determine which option was marked by a user in step 506. For example, referring to the form shown in FIGS. 6A and 6B, a human can mark an answer in numerous ways to indicate a selection. In both FIGS. 6A and 6B, the human answered “No” to all the questions in the form, including answering “No” for all the possible symptoms of COVID-19. In one instance, the human used a tick mark to indicate a selection (FIG. 6B), whereas in another, a human used an X mark across multiple checkboxes (FIG. 6A) to indicate a selection. The digital document processing subsystem 402 can determine a handwritten selection in either scenario and many others (single line mark, filling the entire box, etc.). The digital document processing subsystem 402 can determine the location of checkboxes or other selection areas or use a prestored template as a basis for determining where handwritten selections may be marked. Step 506 is described with further detail in reference to FIG. 7.

Additionally, for each page, the digital document processing subsystem 402 can find areas where handwritten answers were entered into the form, crop the area of the page where a handwritten answer was written, and use a handwriting OCR module or service, as would be known by those having skill in the art, to determine what characters were handwritten in step 508. In some embodiments, the cropped area may create another image file that is provided to the handwriting OCR module or service. One example of the handwriting OCR module or service is Amazon Textract.

After determining the checkbox selections and the handwritten answers into the form, the digital document processing subsystem 402 can save the answers and selections into a database in step 510.

FIG. 7 illustrates a method 700 determining a selection in a form from a multiple choice option (e.g., Yes or No) according to an example embodiment. The method 700 shows the detailed steps necessary to perform step 506 in FIG. 5. The method 700 may be performed by the benefit manager device 102, partially by the benefit manager device 102 and partially by the another device, or may be otherwise performed. For the sake of simplicity, the digital document processing subsystem 402 will be described as performing the steps of the method 700, but the embodiments described herein are not so limited.

According to an exemplary embodiment, upon receiving a new page to process, the digital document processing subsystem 402 can greyscale each pixel so that each pixel has a value of either “0” or “1” in step 702. In one embodiment, a pixel having a value of “0” can indicate white space, whereas a pixel having a value of “1” can indicate black, printed area, such as a line in a checkbox form or an underscore indicating a blank for a handwritten answer. The digital document processing subsystem 402 can further determine a number of pixels per inch in the image. In some embodiments, the digital document processing subsystem 402 can apply a gaussian blur, but a gaussian blur process may not be necessary.

After step 702, the digital document processing subsystem 402 can rotate the image, if necessary, in step 704 so that any lines in the form are vertical and horizontal. In some embodiments, the rotated image can be further padded with whitespace, but padding may not be necessary in all instances. The digital document processing subsystem 402 can perform additional adjustments during rotation using small angle increments and moving the image left, right, up or down to find the best angle and best fit for future processing.

Subsequently, the digital document processing subsystem 402 can attempt to identify the form using prestored templates of known forms in step 706. The digital document processing subsystem 402 can attempt to identify a form using a base for coordinates or multiple bases for coodinates. A base for a coordinate can be an X coordinate or a Y coordinate. In one embodiment, the digital document processing subsystem 402 finds four bases for coordinates, which include two X coordinates and two Y coordinates to form corners of a rectangle corresponding to a checkbox on the form. If multiple bases of coordinates can be matched to a prestored template, then the digital document processing subsystem 402 can be reasonably certain that the form has been identified. If the form cannot be identified, the digital document processing subsystem 402 can process the form and create a new template.

The process of identifying a form can include finding left-right printed bars on the form and up-down printed bars on the form. Consider an image that was rotated and each pixel given a binary value (0 or 1) according to steps 702 and 704. If the image has a size of 8.5×11″, with 100 pixels per inch, then the image would have 8500×1100 pixels. The digital document processing subsystem 402 can project the image left or right into a vector of length 1100, where each value is the sum of the 0-1 decimal values in that row of pixels. Then, a location of a pin-stripe 604A or 604B near the top can be found since it will have the largest sum (e.g., near 8000). The pin-stripe 604A, 604B may be a few pixels thick. Finding the pin-stripe 604A, 604B can indicate the top of a form. Other features in a form can be used to find the top of the form.

The digital document processing subsystem 402 can find a y-coordinate of a middle of the pin-stripe 604A, 604B. After projecting left-right to form the function ƒ(y), and applying reasonable bounds on a final location, approximate a target pattern with a bell-curve g(y) of similar standard-deviation. The location of the center of the bar is at argmax (i.e., a specific point in a function's domain where the function's value is maximized) i<f(y), g(y−i)>. This shift i is the location of the bell-curve that most closely “matches” the projected function. Hence, the digital document processing subsystem 402 can find the largest “hump” of a certain width in f(y). Other features in a form can be used to find the middle of the form.

Upon identifying a template, the digital document processing subsystem 402 can superimpose boxes over the rotated image in step 708 using the determined top of the form and the determined middle of the form. In some embodiments, the superimposed boxes can come from data associated with the stored template. Indeed, the stored template can include an approximate coordinate system identifying the location of the superimposed boxes. The superimposed boxes can have lines approximately 1 pixel in width or height. The digital document processing subsystem 402 can adjust each box up to 1/16^{th} of an inch to find (dx, dy), which are adjustments in pixels in the x and y directions, to find the best fit. Finding dx and dy consider a line integral that sums the original 2D, binary image along a border of a superimposed box estimate, which corresponds to the inner product and/or cosine similarity of the original image with a “mask” that outlines just the border of one box. The dx and dy values that maximize this inner product, subject to only moving 1/16^{th} of an inch, determine the location of the best fit box, that aligns with the checkbox. In a rectangular checkbox embodiment, the digital document processing subsystem 402 can independently optimize for dx, then dy using brute force. Therefore, in a rectangular embodiment for the checkboxes, digital document processing subsystem 402 may not need to use any gradient descent.

After superimposing the boxes, the digital document processing subsystem 402 can learn locations for checkboxes or multiple-choice selection boxes in the form. The digital document processing subsystem 402 can begin the process to determine whether each checkbox or multiple choice was marked or not by hand. In step 710, the digital document processing subsystem 402 can crop the interior of an answer box and determine if a deliberate mark exists through the cropped interior by determining whether sufficient dark marks and variability in pixel values exists. In some embodiments, the cropping process can exclude the black markings defining the checkbox borders so that only interior portions of the checkbox are cropped, such as by omitting a predetermined portion of each edge of the cropped interior. In some embodiments, if the checkbox is uniform in color, the digital document processing subsystem 402 can determine that the checkbox was not checked, whereas major variations in color indicate it was checked. In step 712, the digital document processing subsystem 402 can store the selection of the checkbox determined to be marked in a database in step 712.

In some embodiments, the digital document processing subsystem 402 can apply rules to ensure that false positives are not generated. For example, in a form where the multiple-choice selection is a Yes or No question, the digital document processing subsystem 402 will ensure that it does not determine that a user selected both “Yes” and “No”. Furthermore, if one answer is more likely the selected answer, such as by having a greater variation in pixel color, then the digital document processing subsystem 402 may select the checkbox having the greater variation in color. Alternatively, if the form allows for multiple selections, then the digital document processing subsystem 402 may not apply the rules that only allow one answer per row of checkboxes, or the like.

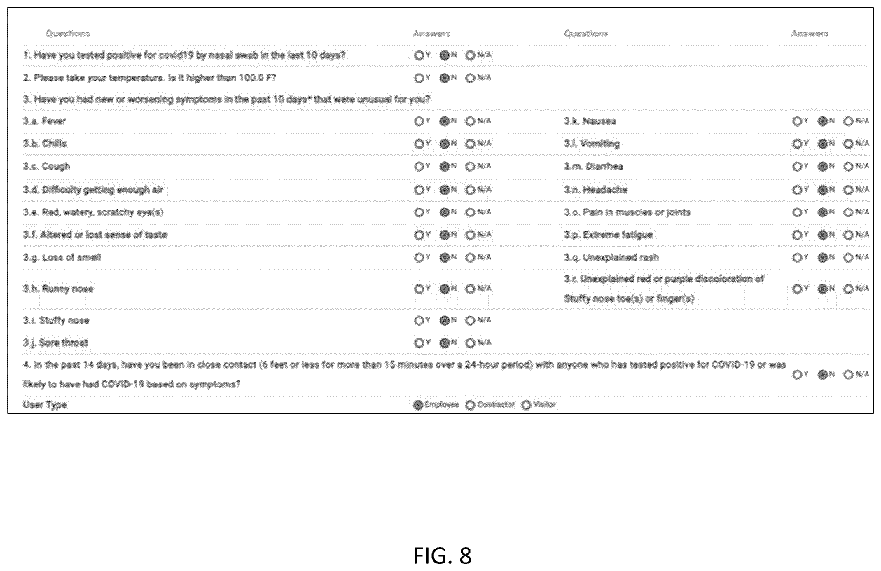

After storing answers and markings in a form to the database, a user can search for and find the answers from the form in a user interface, as shown in FIG. 8. The computer-readable answers displayed in FIG. 8 correspond with the hand-filled answers on the forms shown in FIGS. 6A and 6B.

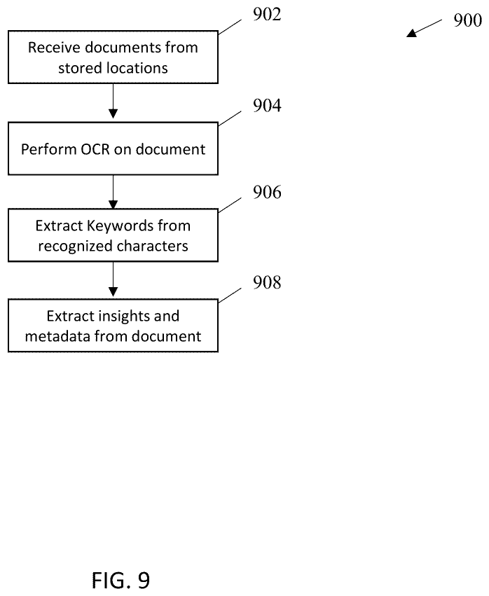

FIG. 9 illustrates a method 900 for processing digital documents according to an example embodiment. The method 900 may be performed by the benefit manager device 102, partially by the benefit manager device 102 and partially by the another device, or may be otherwise performed. For the sake of simplicity, the document review subsystem 404 will be described as performing the steps of the method 700, but the embodiments described herein are not so limited.

According to an exemplary embodiment, the document review subsystem 404 can receive a location or multiple location where digital versions of documents, such as contracts, are stored in step 902. The documents can be stored in any format, including PDF, GIF, JPG, TIFF, or any other file format. For each document, the document review subsystem 404 can perform OCR on each page of the document in step 904, if necessary. The document review subsystem 404 can skip step 904 for any file format where characters are already computer readable (e.g., WORD or TXT). The document review subsystem 404 can store a page number as metadata for each character recognized during the OCR process in step 904. In some embodiments, the OCR process uses Tesseract OCR to perform OCR. Once all the characters and words are recognized in a file, the document review subsystem 404 can extract keywords from the recognized characters and words in the document in step 906. Also, the document review subsystem 404 can apply machine learning or another artificial intelligence algorithm to extract insights and metadata from the document in step 908. The insights and metadata can be stored with the document after processing.

Step 908, which extracts insights and metadata, can comprise one or more sub-steps to determine and create the insights/metadata. For example, the document review subsystem 404 can search for keywords within the document after the OCR process in step 904. In one embodiment, the keywords can be provided by a user to identify the insights. In another embodiment, the keywords can be determined by a machine learning algorithm having been trained on exemplary contracts stored in the database. In some examples, the insights can include contract type (NDA, privacy restrictions, etc.) or the insights can include the parties to the contract. The insights can create an index of contracts for quick searching or to determine which third parties have bound a company associated with the document review subsystem 404. Additional insights can include flagging privacy terms, which might mean preventing other computer services from sharing a subset of information stored in the database with third parties as a result of the contract terms determined by the document review subsystem 404. Step 908 may further include the document review subsystem 404 searching for a combination of words in a similar area. For example, if the phrases “non”, “disclosure” and “agreement” all appear on the first page of a document reviewed by the document review subsystem 404, then the document review subsystem 404 can determine that the contract is an NDA. In this example, the document review subsystem 404 may further determine the parties to the NDA and the type of information that cannot be disclosed by one or both parties. Still furthering this example, the document review subsystem 404 may flag information shared in the database and prevent any external transfer of the data as a result of determining the contract insights and the contract terms.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example methods and systems for using machine learning algorithms are described. In the following description, for purposes of explanation, numerous specific details are set forth in order to provide a thorough understanding of example embodiments. It will be evident, however, to one of ordinary skill in the art that embodiments of the present disclosure may be practiced without these specific details.

1. A method comprising:
a digital document processing subsystem monitoring a database location for a file to process;
after identifying a file to process, the digital document processing subsystem identifying a location of one or more multiple-choice selection areas within the file; and
the digital document processing subsystem determining whether each of the one or more multiple choice selection areas were marked by hand and storing results of the determination in a database,
wherein identifying the location of the one or more multiple choice selection areas within the file comprises identifying a top of a page of the file and a middle of the page of the file and superimposing a prestored template associated with the file to align lines in the template with lines on the page of the file, applying selection area coordinates stored in the template to the file to identify the one or more multiple choice selection areas, and
wherein determining whether each of the one or more multiple choice selection areas were marked by hand comprises determining if a deliberate mark exists within an interior of each of the one or more multiple-choice selection areas by deciding whether sufficient dark marks or variability in pixel values exists.

2. The method of claim 1 further comprising:
the digital document processing subsystem extracting each page of the file to process each page individually; and
the digital document processing subsystem filtering out a plurality of unnecessary data from file.

3. The method of claim 1 further comprising:
the digital document processing subsystem identifying one or more areas having handwriting within the file;
the digital document processing subsystem cropping the one or more areas having handwriting;
the digital document processing subsystem providing the one or more cropped areas having handwriting to a handwriting OCR module or service; and
handwriting OCR module or service determining what characters were handwritten.

4. The method of claim 1 wherein identifying the top of the page of the file and the middle of the page of the file further comprises:
the digital document processing subsystem greyscaling each pixel of the page such that each pixel has a binary value indicating whether the pixel represents whitespace or printed area;
the digital document processing subsystem determining a number of pixels per inch in the page; and
the digital document processing subsystem rotating the page so that at least one line on the page are substantially vertical or horizontal.

5. The method of claim 4 further comprising the digital document processing subsystem performing additional adjustments during rotation using small angle increments and moving the page up, down, left or right.

6. The method of claim 4 wherein identifying the top of the page of the file and the middle of the page of the file further comprises:
the digital document processing subsystem identifying at least one base for coordinates; and
the digital document processing subsystem aligning the base for coordinates in the page with similar coordinates in the prestored template to align the superimposed template with the page.

7. The method of claim 6 wherein identifying the top of the page of the file further comprises:
the digital document processing subsystem projecting the page left or right into a vector of a predetermined value based on the pixels per inch; and
determining the top of the page by finding a pixel row having the largest sum.

8. The method of claim 7 wherein identifying the middle of the page of the file further comprises
the digital document processing subsystem forming a function ƒ(y) after projecting the page left or right into the vector of the predetermined value;
the digital document processing subsystem approximating a target pattern with a bell-e curve g(y); and
the digital document processing subsystem identifying the middle of the page of the file by determining a set of points in a function's domain where f(y) and g(y) value is maximized.

9. The method of claim 1 wherein applying selection area coordinates stored in the template to the file to identify the one or more multiple choice selection areas further comprises adjusting each of the coordinates of the superimposed boxes by a predetermined area to find a fit for the superimposed boxes to correspond with the file.

10. The method of claim 1 wherein determining whether each of the one or more multiple choice selection areas were marked by hand further comprises cropping off borders of the identified one or more multiple choice selection areas to remove at least one border defining the one or more multiple choice selection areas in the file.

11. A system for automatic processing prescription, comprising:
a database for storing one or more files and one or more prestored templates; and
a digital document processing subsystem configured to (a) monitor a database location for a file to process, (b) identify a location of one or more multiple-choice selection areas within the file, and (c) determine whether each of the one or more multiple choice selection areas were marked by hand and storing results of the determination in a database,
wherein the digital document processing subsystem identifies the location of the one or more multiple choice selection areas within the file by being further configured to identify a top of a page of the file and a middle of the page of the file, superimpose a prestored template associated with the file to align lines in the template with lines on the page of the file, and apply selection area coordinates stored in the template to the file to identify the one or more multiple choice selection areas, and
wherein the digital document processing subsystem determines whether each of the one or more multiple choice selection areas were marked by hand by being further configured to determine if a deliberate mark exists within an interior of each of the one or more multiple-choice selection areas by deciding whether sufficient dark marks or variability in pixel values exists.

12. The system of claim 11 wherein the digital document processing subsystem is further configured to extract each page of the file to process each page individually and filter out a plurality of unnecessary data from file.

13. The system of claim 11 further comprising a handwriting OCR module or service, wherein the digital document processing subsystem is further configured to identify one or more areas having handwriting within the file, crop the one or more areas having handwriting, and provide the one or more cropped areas having handwriting to the handwriting OCR module or service to determine what characters were handwritten.

14. The system of claim 11 wherein the digital document processing subsystem is further configured to greyscale each pixel of the page such that each pixel has a binary value indicating whether the pixel represents whitespace or printed area, determine a number of pixels per inch in the page, and rotate the page so that at least one line on the page are substantially vertical or horizontal.

15. The system of claim 14 wherein the digital document processing subsystem is further configured to perform additional adjustments during rotation using small angle increments and moving the page up, down, left or right.

16. The system of claim 14 wherein the digital document processing subsystem is further configured to identify at least one base for coordinates, and align the base for coordinates in the page with similar coordinates in the prestored template to align the superimposed template with the page.

17. The system of claim 16 wherein the digital document processing subsystem is further configured to project the page left or right into a vector of a predetermined value based on the pixels per inch, and determine the top of the page by finding a pixel row having the largest sum.

18. The system of claim 17 wherein the digital document processing subsystem is further configured to form a function ƒ(y) after projecting the page left or right into the vector of the predetermined value, approximate a target pattern with a bell-curve g(y), and identify the middle of the page of the file by determining a set of points in a function's domain where f(y) and g(y) value is maximized.

19. The system of claim 11 wherein the digital document processing subsystem is further configured to adjust each of the coordinates of the superimposed boxes by a predetermined area to find a fit for the superimposed boxes to correspond with the file.

20. The system of claim 11 wherein the digital document processing subsystem is further configured to crop off borders of the identified one or more multiple choice selection areas to remove at least one border defining the one or more multiple choice selection areas in the file.

21. A non-transitory machine-readable medium comprising instructions, which, when executed by one or more processors, cause the one or more processors to perform the following operations:
monitor a database location for a file to process;
identify a location of one or more multiple-choice selection areas within the file by identifying a top of a page of the file and a middle of the page of the file, superimposing a prestored template associated with the file to align lines in the template with lines on the page of the file, and applying selection area coordinates stored in the template to the file to identify the one or more multiple choice selection areas; and
determine whether each of the one or more multiple choice selection areas were marked by hand and storing results of the determination in a database by determining if a deliberate mark exists within an interior of each of the one or more multiple-choice selection areas by deciding whether sufficient dark marks or variability in pixel values exists.

22. A method comprising:
a document review subsystem receiving at least one location where digital versions of documents are stored in a database;
the document review subsystem performing optical character recognition on the digital versions of the documents;
the document review subsystem extracting insights from the documents by searching for keywords within the document to determine the document type;
the document review subsystem determining parties to a contract in the document after determining the document type; and
the document review subsystem extracting at least one key term of the contract based on the document type and the keywords.

23. The method of claim 22, wherein the document review subsystem performs optical character recognition using Tesseract OCR.

24. The method of claim 22, wherein the document review subsystem determines the keywords using a machine learning algorithm training using a set of known contracts stored in the database.

25. The method of claim 22, further comprising the document review subsystem flagging data stored in the database, wherein the flagging prevents the document review subsystem from transmitting the data to an external computer system.

26. A system for automatic processing prescription, comprising:
a database for storing one or more files and one or more prestored templates; and
a document review subsystem configured to (a) receive at least one location where digital versions of documents are stored in a database, (b) perform optical character recognition on the digital versions of the documents, (c) extract insights from the documents by searching for keywords within the document to determine the document type, (d) determine parties to a contract in the document after determining the document type, and (e) extract at least one key term of the contract based on the document type and the set of keywords.

27. The system of claim 26, wherein the document review subsystem is further configured to perform optical character recognition using Tesseract OCR.

28. The system of claim 26, wherein the document review subsystem is further configured to determine the keywords using a machine learning algorithm training using a set of known contracts stored in the database.

29. The system of claim 26, wherein the document review subsystem is further configured to flag data stored in the database, wherein the flagging prevents the document review subsystem from transmitting the data to an external computer system.
